(19) United States
(12) Patent Application Publication
(10) Pub. No.: US 2026/0323193 A1
(43) Pub. Date: Oct. 15, 2026

(54) CONDUCTIVE BRACKET, SPEAKER DEVICE, AND SMART GLASSES

(71) Applicant: MERRY ELECTRONICS (SUZHOU) CO., LTD., Jiangsu Province (CN)

(72) Inventors: Liguo RAO, Suzhou (CN); Chunlong ZHENG, Suzhou (CN); Mingya LUO, Suzhou (CN)

(73) Assignee: MERRY ELECTRONICS (SUZHOU) CO., LTD., Jiangsu Province (CN)

(21) Appl. No.: 19/462,462

(22) Filed: Jan. 28, 2026

(30) Foreign Application Priority Data
Mar. 25, 2025 (CN) 202510360811.0

(51) Int. Cl. H04R 1/02; G02C 11/00; H04R 1/06; H04R 9/02; H04R 9/04; H04R 9/06

(52) U.S. Cl. CPC H04R 1/025; G02C 11/10; H04R 1/028; H04R 1/06; H04R 9/025; H04R 9/046; H04R 9/06; H04R 2400/11

(57) ABSTRACT

A conductive bracket, a speaker device, and a smart glasses are provided. The conductive bracket includes a frame provided with an accommodating space; a separating member provided on the frame and dividing the accommodating space into two accommodating openings spaced apart along a length direction of the frame, the separating member being further provided with a first mounting groove and a second mounting groove, the first mounting groove including two first grooves extending through the separating member along a thickness direction of the frame; and a pole plate fixing base received in each accommodating opening, respectively.

### CROSS-REFERENCE TO RELATED APPLICATIONS

This application claims priority to Chinese Patent Application No. 2025103608110, filed on Mar. 25, 2025, the content of which is hereby incorporated by reference in its entirety.

### TECHNICAL FIELD

The present disclosure relates to the field of smart glasses technology, and in particular to a conductive bracket, a speaker device, and a smart glasses.

### BACKGROUND

As an electroacoustic conversion device, speaker devices are widely used in electronic devices such as automobiles, mobile phones, AR or VR devices, and smart glasses.

Currently, more and more smart glasses integrate the speaker devices into themselves to address the problems of external speaker devices, which have high requirements for indoor space and sound insulation, are inconvenient to use, and are too expensive.

However, most of the speaker devices equipped on the smart glasses currently available on the market are relatively large in size, which forces the temple arms that house the speaker devices to be designed quite wide, which not only makes the overall structure of the smart glasses bulky and not exquisite enough, but also makes the smart glasses occupy a lot of space when stored and worn, causing inconvenience to users.

### SUMMARY

According to various embodiments, the present disclosure provides a conductive bracket, a speaker device, and a smart glasses.

In an aspect, a conductive bracket for a speaker device is provided. The conductive bracket includes a frame provided with an accommodating space; a separating member provided on the frame and dividing the accommodating space into two accommodating openings spaced apart along a length direction of the frame, the separating member being further provided with a first mounting groove and a second mounting groove, the first mounting groove including two first grooves extending through the separating member along a thickness direction of the frame; and a pole plate fixing base received in each accommodating opening, respectively.

In another aspect, a speaker device is provided. The speaker device includes the conductive bracket as described above and a speaker assembly provided on the conductive bracket.

In yet another aspect, a smart glasses is provided. The smart glasses includes a glasses body and the speaker device as described above, and the speaker device is provided inside the glasses body.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 is a perspective view of a conductive bracket according to some embodiments of the present disclosure.

FIG. 2 is a perspective view of the conductive bracket of FIG. 1 viewed from another aspect.

FIG. 3 is a perspective view illustrating that a first conductive member, a second conductive member and a damping adhesive are connected to the conductive bracket.

FIG. 4 is a perspective view illustrating that a side pole plate is connected to the conductive bracket.

FIG. 5 is a perspective view of a speaker device according to some embodiments of the present disclosure.

FIG. 6 is a perspective view of the speaker device of FIG. 5 viewed from another aspect.

FIG. 7 is a cross-sectional view of the speaker device of FIG. 5.

FIG. 8 is a perspective view illustrating that a second conductive member of the speaker device is connected to second lead wires.

FIG. 9 is a schematic view of smart glasses according to some embodiments of the present disclosure.

### DESCRIPTION OF REFERENCE NUMERALS

1. Conductive bracket;

11. Frame; 110. Accommodating space; 111. Accommodating opening; 112. Lead wire fixing base; 113. Pole plate fixing base; 114. First engagement structure; 115. Fixing engagement base; 116. Connecting base; 117. First connecting groove; 118. First surface; 119. Second surface;

12. Separating member; 121. First mounting groove; 122. Second mounting groove; 123. First groove; 124. Second groove; 125. Second connecting groove;

2. Speaker device;

21. Voice coil; 22. First conductive member; 221. First lead wire; 23. Second conductive member; 231. Second lead wire; 232. Connecting bending portion; 233. Connecting end; 24. Magnetic yoke;

25. Magnet assembly; 251. Main magnet; 252. Secondary magnet;

26. Side pole plate; 27. Second engagement structure; 28. Upper cover; 29. Damping adhesive;

3. Smart glasses; 31. Glasses body.

### DETAILED DESCRIPTION OF THE EMBODIMENTS

In order to make the above objectives, features and advantages of the present disclosure clear and easier to understand, the specific embodiments of the present disclosure are described in detail below in combination with the accompanying drawings. Many specific details are set forth in the following description to facilitate a full understanding of the present disclosure. However, the present disclosure can be implemented in many ways different from those described herein, and those skilled in the art can make similar improvements without departing from the connotation of the present disclosure. Therefore, the present disclosure is not limited by the specific embodiments disclosed below.

In the description of the present disclosure, it should be understood that the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential direction” are based on the azimuths or position relationships shown in the attached drawings. These terms are only for the convenience of describing the present disclosure and simplifying the description, rather than indicating or implying that the indicated devices or elements must have the specific azimuths, or be constructed or operated in the specific azimuths, and therefore such terms cannot be understood as limitations of the present disclosure.

In addition, the terms “first” and “second” are only used for descriptive purposes and cannot be understood as indicating or implying relative importance or implicitly indicating the number of indicated technical features. Thus, the features defined with “first” and “second” may explicitly or implicitly include at least one of the features. In the description of the present disclosure, “a plurality of” means at least two, such as two, three, etc., unless otherwise expressly and specifically defined.

In the present disclosure, unless otherwise expressly specified and limited, the terms “mount”, “connect”, “couple”, “fix” and the like should be interpreted broadly. For example, the terms can mean fixed connection, detachable connection, or being integrated. The terms can mean mechanical connection or electrical connection. The terms can mean directly connection or indirectly connection through an intermediate medium. The terms can mean connection within two elements or interaction relationship between two elements, unless otherwise expressly limited. For those skilled in the art, the specific meaning of the above terms in the present disclosure should be understood according to the specific situation.

In the present disclosure, unless otherwise expressly specified and limited, a first feature “above” or “below” a second feature may be in direct contact with the second feature, or the first and second features may be in indirect contact through an intermediate medium. Moreover, the first feature “above” the second feature may be right above or obliquely above the second feature, or the first feature may be merely located at a height higher than the second feature. The first feature “below” the second feature may be right below or obliquely below the second feature, or the first feature may be merely located at a height lower than that of the second feature.

It should be noted that when an element is called “fixed to” or “provided on” another element, it can be directly on another element or there can be an intermediate element. When an element is considered to be “connected” to another element, it can be directly connected to another element or there can be an intermediate element. The terms “vertical”, “horizontal”, “up”, “down”, “left”, “right” and similar expressions used herein are for the purpose of illustration only and do not represent the only ways for implementation.

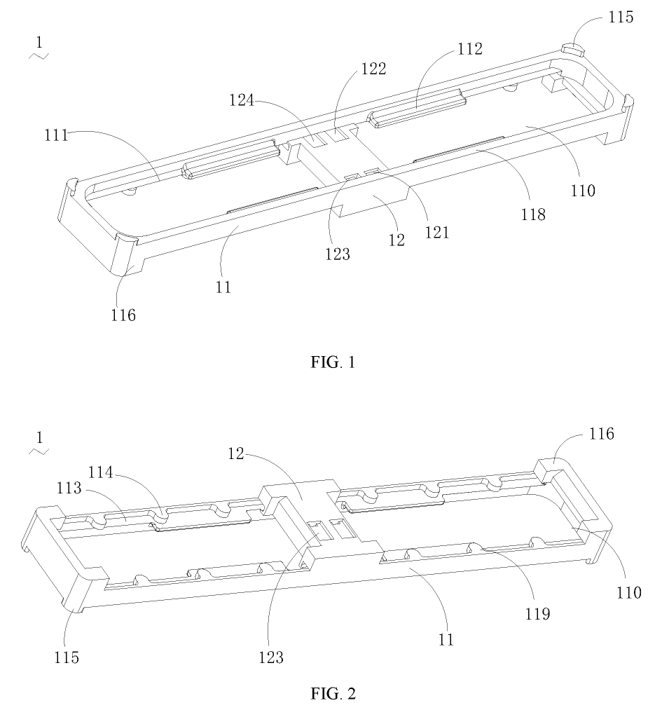

Referring to FIGS. 1 to 4 , in one aspect, a conductive bracket is provided according to an embodiment of the present disclosure, including a frame 11 and a separating member 12. The frame 11 is provided with an accommodating space 110. The separating member 12 is provided on the frame 11 and divides the accommodating space 110 into two accommodating openings 111 spaced apart along a length direction of the frame 11. The frame 11 can be used to accommodate two voice coils 21 through the two accommodating openings 111, thereby enabling a speaker device 2 having the conductive bracket 1 to have a dual voice coil design, so that the speaker device 2 can achieve the best bass effect in a limited space.

A pole plate fixing base 113 is received in each accommodating opening 111, the pole plate fixing base 113 can be used to fix a side pole plate 26 of the speaker device 2, so that the side pole plate 26 can be connected to the conductive bracket 1 in an embedded manner, thereby simplifying the structure of the conductive bracket 1 and reducing assembly cost. Two pole plate fixing bases 113 can be symmetrically arranged on two opposite sides of the accommodating opening 111 along a width direction of the frame 11, or symmetrically arranged on two opposite sides of the accommodating opening 111 along the length direction of the frame 11.

The separating member 12 is provided with a first mounting groove 121 and a second mounting groove 122 spaced apart along the width direction of the frame 11. The first conductive member 22 and the second conductive member 23 connecting the voice coils 21 in the two accommodating openings 111 can be mounted in the first mounting groove 121 and the second mounting groove 122, respectively, such that the first conductive member 22 and the second conductive member 23 can be connected to the conductive bracket 1 in an embedded manner, which effectively simplifies the structure of the conductive bracket 1 and reduces the assembly cost.

Specifically, the first mounting groove 121 includes two first grooves 123, so that two first conductive members 22 connected to two voice coils 21 can be embedded in the two first grooves 123, respectively. The two first grooves 123 are spaced apart along the length direction of the frame 11, so that the two first grooves 123 can be adjacent to the two accommodating openings 111, respectively, and the two first conductive members 22 can be connected to the two voice coils 21, respectively. Each first groove 123 extends through the separating member 12 along a thickness direction of the frame 11, so that positive and negative poles of a power supply device can be connected to the two first conductive members 22, respectively.

When the conductive bracket 1 is assembled, the two first conductive members 22 can be embedded in the two first grooves 123, respectively, and the two first conductive members 22 can be connected to the two voice coils 21 through two first lead wires 221. The second conductive member 23 can be embedded in the second mounting groove 122, and the second conductive member 23 can be connected to the two voice coils 21 through two second lead wires 231. The two voice coils 21 can be energized by connecting the positive and negative poles of the power supply equipment to the two first conductive members 22, respectively.

In summary, according to the aforementioned conductive bracket 1, the side pole plate 26 is fixed through the pole plate fixing base 113, so that the side pole plate 26 can be connected to the conductive bracket 1 in an embedded manner. At the same time, the first mounting groove 121 and the second mounting groove 122 for installing the first conductive member 22 and the second conductive member 23 are directly provided on the conductive bracket 1, so that the first conductive member 22 and the second conductive member 23 configured to be connected to the dual voice coils can be connected to the conductive bracket 1 in an embedded manner. The structure of the conductive bracket 1 is effectively simplified and the assembly cost is reduced, and the problem of large size of the speaker device 2 is solved.

In addition, since the frame 11 is generally made of plastic, the rigidity of the frame 11 can be effectively increased by connecting the side pole plate 26, the first conductive member 22, and the second conductive member 23 to the conductive bracket 1 in an embedded manner, thereby improving the structural stability and load-bearing capacity of the conductive bracket 1.

Referring to FIGS. 1 to 4 , in order to enhance the positioning and fixing effect of the side pole plate 26, in one embodiment, the pole plate fixing base 113 includes a plurality of first engagement structures 114 that are spaced apart, and the side pole plate 26 can be fixed on the pole plate fixing base 113 through the first engagement structures 114.

Specifically, the side pole plate 26 is provided with a plurality of second engagement structures 27, the side pole plate 26 is provided on the pole plate fixing base 113, and the second engagement structures 27 are engaged with the first engagement structures 114, so as to achieve the detachable connection between the side pole plate 26 and the pole plate fixing base 113. It should be understood that in some embodiments, the first engagement structure 114 can be one of a groove and a protrusion, and the second engagement structure 27 can be the other one of a groove and a protrusion. The side pole plate 26 and the pole plate fixing base 113 are connected by inserting the protrusion into the groove.

In order to further ensure the fixing effect of the pole plate fixing base 113 to the side pole plate 26, in one embodiment, the accommodating opening 111 has two mounting surfaces that are arranged opposite to each other along the width direction of the frame 11, and each mounting surface is provided with the pole plate fixing base 113. This structure enables the pole plate fixing base 113 to have a great length along the length direction of the frame 11, so as to increase a contact area between the pole plate fixing base 113 and the side pole plate 26, and thereby enhancing the stability between the pole plate holder 113 and the side pole plate 26.

In addition, in some embodiments, the plurality of first engagement structures 114 are provided, and the plurality of first engagement structures 114 are spaced apart along the length direction of the frame 11. The plurality of second engagement structures 27 are provided, and the plurality of second engagement structures 27 are spaced apart along the length direction of the side pole plate 26, thus the stability between the pole plate fixing base 113 and the side pole plate 26 can be further enhanced.

In order to facilitate the fixing of the first lead wire 221 and the second lead wire 231, and to ensure the stability of the first lead wire 221 and the second lead wire 231 on the frame 11, in one embodiment, a lead wire fixing base 112 is received in each accommodating opening 111. A damping adhesive 29 is provided on the lead wire fixing base 112, and the first lead wire 221 and the second lead wire 231 can be fixed on the lead wire fixing base 112 through the damping adhesive 29.

Specifically, the accommodating opening 111 has two mounting surfaces that are arranged opposite each other along the width direction of the frame 11. Each mounting surface is provided with one lead wire fixing base 112. The lead wire fixing bases 112 on the two mounting surfaces are configured to fix the first lead wire 221 and the second lead wire 231, respectively.

Further, in order to simplify the structure and enhance the rigidity of the lead wire fixing base 112 and the pole plate fixing base 113, in one embodiment, the lead wire fixing base 112 is connected to the pole plate fixing base 113, and both of which are parts of a fixing base.

Referring to FIGS. 2 to 4 , specifically, the accommodating opening 111 has two mounting surfaces that are arranged opposite to each other along the width direction of the frame 11. The fixing base is provided on each mounting surface. The fixing base has a lead wire fixing surface and a pole plate fixing surface that are opposite to each other along the thickness direction of the frame 11. The lead wire fixing surface is located on the lead wire fixing base 112, and the pole plate fixing surface is located on the pole plate fixing base 113. This structure allows the frame 11 to provide only one fixing seat during production to achieve auxiliary fixation of the side pole plate 26, the first lead wire 221 and the second lead wire 231, which can effectively simplify the structure and reduce the production cost.

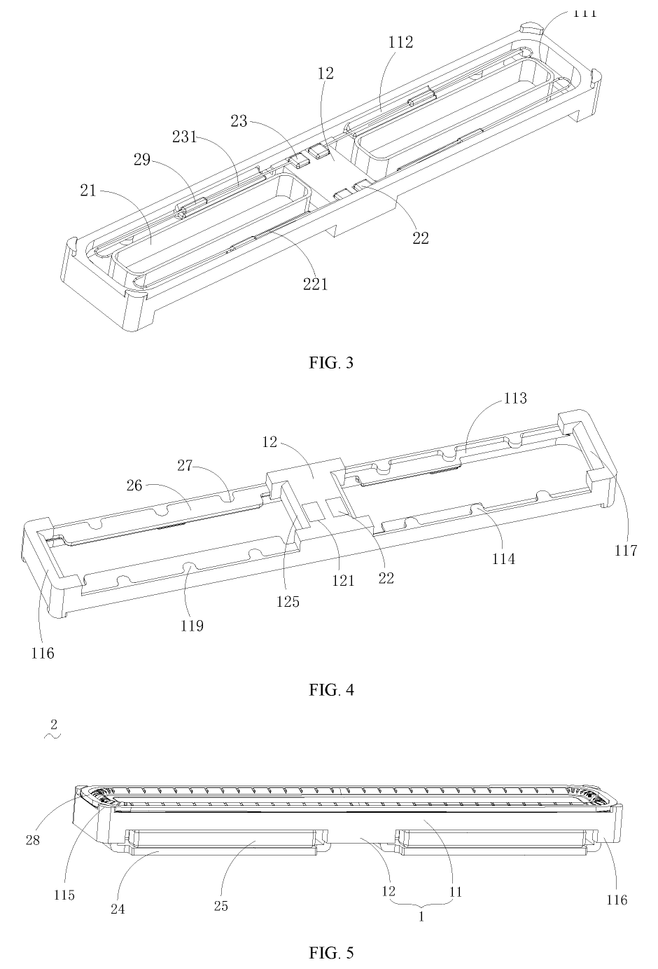

Referring to FIGS. 1,3 and 8, FIG. 3, in order to improve the fixing effect of the second conductive member 23, in one embodiment, the second mounting groove 122 includes a connecting channel and two second grooves 124. The two second grooves 124 are spaced apart along the length direction of the frame 11, and the connecting channel is in communication with the two second grooves 124. This structure can increase a contact area between the second conductive member 23 and the separating member 12, thereby enhancing the stability of the second conductive member 23 fixed in the separating member 12 through the second mounting groove 122.

It should be understood that in some embodiments, the second conductive member 23 is configured to adapt to the second mounting groove 122. Specifically, the second conductive member 23 includes a connecting bending portion 232 and two connecting ends 233. The two connecting ends 233 are located in the two second grooves 124, respectively. The connecting bending portion 232 is provided in the connecting channel inside the separating member 12 and connected between the two connecting ends 233. When the second conductive member 23 is connected to the two voice coils 21 through the two second lead wires 231, one end of each of the two second lead wires 231 may be connected to the two connecting ends 233 respectively, and the other end of each of the two second lead wires 231 may be connected to the two voice coils 21, respectively. A current can flow sequentially through one of the connecting ends 233, the connecting bending portion 232 to the other one of the connecting ends 233.

In the above structure, the two connecting ends 233 are located in the two second grooves 124, respectively, the connection between the connecting ends 233 and the second lead wires 231 can be facilitated. The connecting bending portion 232 is provided inside the separating member 12, the stability of the second conductive member 23 in the separating member 12 can be effectively enhanced.

Referring to FIG. 1 to FIG. 3, in one embodiment, the second groove 124 and the first groove 123 are spaced apart along the width direction of the frame 11, so that when the first conductive member 22 and the second conductive member 23 are mounted in the first mounting groove 121 and the second mounting groove 122, respectively, the connecting ends 233 of the first conductive member 22 and the second conductive member 23 can be spaced apart along the width direction of the frame 11, which not only makes the overall structure more regular, but also makes the lengths of the first lead wire 221 and the second lead wire 231 configured to connect to the first conductive member 22 and the second conductive member 23 consistent, thereby significantly improving signal integrity, reducing electromagnetic interference, improving reliability, simplifying design and manufacturing, and improving the convenience of repair and maintenance.

It should be understood that, consistent lead wire length ensures that signals have the same delay time during transmission, thereby reducing signal distortion and timing issues; At the same time, differences in electromagnetic radiation can be reduced, electromagnetic interference can be reduced, which helps improve the anti-interference ability of a circuit, and reduces the impact of external electromagnetic interference on the signal. In addition, consistent lead wire length can reduce mechanical stress caused by inconsistent lengths, improve the mechanical stability of the lead wires, reduce poor contact or short circuit problems caused by length differences, improve system reliability, simplify manufacturing processes, reduce adjustment and calibration steps in the production process, and improve production efficiency. Therefore, the above structure significantly improves signal integrity, reduces electromagnetic interference, improves reliability, simplifies design and manufacturing, and improves the convenience of repair and maintenance by making the lengths of the first lead wire 221 and the second lead wire 231 consistent.

Referring to FIGS. 1,2 and 5, in one embodiment, the frame 11 has a first surface 118 and a second surface 119 that are opposite to each other along the thickness direction thereof. A fixing engagement base 115 is provided at each of four corners of the first surface 118. An upper cover 28 of the speaker device 2 can be fixed to the first surface 118 through the fixing engagement base 115 to achieve the connection between the upper cover 28 and the frame 11, so that the upper cover 28 can effectively protect a diaphragm, the voice coil 21, and a magnetic circuit assembly inside the speaker device 2, thereby preventing external objects such as dust, moisture, etc. from entering to ensure the normal operation of the speaker device and prolong its service life.

In one embodiment, along the length direction of the frame 11, two connecting bases 116 are provided at both ends of the second surface 119, respectively. A side of the connecting base 116 facing the separating member 12 is provided with a first connecting groove 117. A side of the separating member 12 facing the connecting base 116 is provided with a second connecting groove 125. Two ends of a magnetic yoke 24 of the speaker device 2 can be fixed in the first connecting groove 117 and the second connecting groove 125, respectively, so as to achieve the connection between the magnetic yoke 24 and the frame 11, so that the magnetic yoke 24 can guide the magnetic flux and reduce magnetic leakage in a magnetic circuit.

Referring to FIGS. 5 to 7 a speaker device 2 is provided according to an embodiment of the present disclosure, including the conductive bracket 1 as described in any of the above embodiments and a speaker assembly provided on the conductive bracket 1. The speaker assembly includes a voice coil 21, a first conductive member 22, a second conductive member 23, a magnetic yoke 24, a magnet assembly 25, a side pole plate 26, an upper cover 28, a diaphragm, and other components. The conductive bracket 1 is configured to cooperate with the components of the speaker assembly to form the speaker device 2.

Specifically, referring to FIGS. 1 to 4, the conductive bracket 1 includes a frame 11 and a separating member 12. The frame 11 is provided with an accommodating space 110. The separating member 12 is provided on the frame 11 and divides the accommodating space 110 into two accommodating openings 111 spaced apart along a length direction of the frame 11. The frame 11 can accommodate two voice coils 21 through the two accommodating openings 111, thereby enabling the speaker device 2 mounted with the conductive bracket 1 to have a dual voice coil design, so that the speaker device 2 can achieve the best bass effect in a limited space.

A pole plate fixing base 113 is provided in each accommodating opening 111, which can be used to fix the side pole plate 26 of the speaker device 2, so that the side pole plate 26 can be connected to the conductive bracket 1 in an embedded manner, thereby simplifying the structure of the conductive bracket 1 and reducing assembly cost. The pole plate fixing bases 113 can be symmetrically arranged on two opposite sides of the accommodating opening 111 along a width direction of the frame 11, or symmetrically arranged on two opposite sides of the accommodating opening 111 along the length direction of the frame 11.

The separating member 12 is provided with a first mounting groove 121 and a second mounting groove 122 spaced apart along the width direction of the frame 11, so that the first conductive member 22 and the second conductive member 23 connecting the voice coils 21 in the two accommodating openings 111 can be mounted in the first mounting groove 121 and the second mounting groove 122, so as to be connected to the conductive bracket 1 in an embedded manner, which effectively simplifies the structure of the conductive bracket 1 and reduces the assembly cost.

According to the aforementioned speaker device 2, the side pole plate 26 is fixed through the pole plate fixing base 113 of the conductive bracket 1, so that the side pole plate 26 can be connected to the conductive bracket 1 in an embedded manner. At the same time, the first mounting groove 121 and the second mounting groove 122 for installing the first conductive member 22 and the second conductive member 23 are directly provided on the conductive bracket 1, so that the first conductive member 22 and the second conductive member 23 configured to be connected to the dual voice coils can be connected to the conductive bracket 1 in an embedded manner. The structure of the conductive bracket 1 is effectively simplified and the assembly cost is reduced, and the problem of large size of the speaker device 2 is solved.

In one embodiment, the speaker assembly includes two voice coils 21, which are respectively located in two accommodating openings 111, so that the speaker device 2 has a dual voice coil design and can achieve the best bass effect in a limited space.

The first mounting groove 121 includes two first grooves 123, so that two first conductive members 22 connected to two voice coils 21 can be embedded in the two first grooves 123, respectively. The two first grooves 123 are spaced apart along the length direction of the frame 11. The two first conductive members 22 are provided in the two first grooves 123 and are connected to the two voice coils 21 through two first lead wires 221 respectively. The second conductive member 23 is provided in the second mounting groove 122 and is connected to the two voice coils 21 through two second lead wires 231.

It should be understood that when the conductive bracket 1 is assembled, the two first conductive members 22 can be embedded in the two first grooves 123, respectively, and the two first conductive members 22 can be connected to the two voice coils 21 through two first lead wires 221. The second conductive member 23 can be embedded in the second mounting groove 122, and the second conductive member 23 can be connected to the two voice coils 21 through two second lead wires 231. The two voice coils 21 can be energized by connecting the positive and negative poles of the power supply equipment to the two first conductive members 22, respectively.

In one embodiment, a length of the first conductive member 22 along the thickness direction of the frame 11 is greater than or equal to a length of the separating member 12 along the thickness direction of the frame 11, so that the first conductive member 22 in the first groove 123 can be connected to the first lead wire 221.

Specifically, in one embodiment, the first groove 123 extends through the separating member 12 and has two openings on both sides of the separating member 12 along the thickness direction of the frame 11. The length of the first conductive member 22 along the thickness direction of the frame 11 is greater than the length of the separating member 12 along the thickness direction of the frame 11, so that the two ends of the first conductive member 22 extend through the two openings of the first groove 123 respectively, so that the first lead wire 221 can be connected to the end of the first conductive member 22 located outside the opening.

In another embodiment, the first groove 123 extends through the separating member 12 and has two openings on both sides of the separating member 12 along the thickness direction of the frame 11. The length of the first conductive member 22 along the thickness direction of the frame 11 is equal to the length of the separating member 12 along the thickness direction of the frame 11, so that the two ends of the first conductive member 22 are located at the two openings of the first groove 123, respectively, so that the first lead wire 221 can be connected to the end of the first conductive member 22 located outside the opening.

Referring to FIGS. 1,3 and 8, , in one embodiment, the second conductive member 23 includes a connecting bending portion 232 and two connecting ends 233. The second mounting groove 122 includes a connecting channel and two second grooves 124. The two second grooves 124 are spaced apart along the length direction of the frame 11, and the connecting channel is in communication with the two second grooves 124. The two connecting ends 233 are located in the two second grooves 124, respectively, so as to be connected to the second lead wires 231. The connecting bending portion 232 is provided inside the separating member 12 to enhance the stability of the second conductive member 23 located on the separating member 12. The connecting bending portion 232 is connected to the two connecting ends 233 to conduct a current.

When the second conductive member 23 is connected to the two voice coils 21 through the two second lead wires 231, one end of each of the two second lead wires 231 may be connected to the two connecting ends 233 respectively, and the other end of each of the two second lead wires 231 may be connected to the two voice coils 21 respectively. A current can flow sequentially through one of the connecting ends 233, the connecting bending portion 232 to the other one of the connecting ends 233. The above structure can facilitate the connection between the second conductive member 23 and the second lead wire 231, while increasing the contact area between the second conductive member 23 and the separating member 12, thereby enhancing the stability of the second conductive member 23 fixed in the separating member 12 through the second mounting groove 122.

Referring to FIGS. 3 and 7 , in one embodiment, the first lead wire 221 is fixed to the lead wire fixing base 112 by a damping adhesive 29 to ensure the stability of the first lead wire 221 after being mounted. The second lead wire 231 is fixed to the lead wire fixing base 112 by a damping adhesive 29 to ensure the stability of the second lead wire 231 after being mounted.

Referring to FIGS. 3,3 and 7, in one embodiment, the speaker assembly includes a side pole plate 26, and a second engagement structure 27 is provided on the side pole plate 26. The side pole plate 26 is provided on the pole plate fixing base 113, and the second engagement structure 27 is engaged with a first engagement structure 114.

In order to facilitate the fixing of the side pole plate 26 of the speaker device 2, the side pole plate 26 can be connected to the conductive bracket 1 in an embedded manner, thereby simplifying the structure of the conductive bracket 1 and reducing the assembly cost. In some embodiments, the accommodating opening 111 has two mounting surfaces that are arranged opposite to each other along the width direction of the frame 11. A pole plate fixing base 113 is provided on each mounting surface, and the side pole plate 26 can be fixed on the frame 11 through the pole plate fixing base 113.

Specifically, referring to FIGS. 2 to 4 , along the length direction of the frame 11, the pole plate fixing base 113 is provided with a plurality of first engagement structures 114 that are spaced apart, and the side pole plate 26 can be fixed on the pole plate fixing base 113 through the first engagement structures 114. Specifically, the side pole plate 26 is provided with a plurality of second engagement structures 27, and the side pole plate 26 is provided on the pole plate fixing base 113, and the plurality of second engagement structures 27 are engaged with the plurality of first engagement structures 114, respectively, so as to achieve the detachable connection between the side pole plate 26 and the pole plate fixing base 113. It should be understood that in the embodiments of the present disclosure, the first engagement structure 114 can be one of a groove and a protrusion, and the second engagement structure 27 can be the other one of a groove and a protrusion. The side pole plate 26 and the pole plate fixing base 113 are connected by inserting the protrusion into the groove.

In addition, since the frame 11 is generally made of plastic, the rigidity of the frame 11 can be effectively increased by connecting the side pole plate 26 to the conductive bracket 1 in an embedded manner, thereby improving the structural stability and load-bearing capacity of the conductive bracket 1.

Further, in the embodiments, the lead wire fixing base 112 and the pole plate fixing base 113 are connected to each other and are both parts of a fixing base to simplify the structure.

Specifically, the accommodating opening 111 has two mounting surfaces that are arranged opposite to each other along the width direction of the frame 11. A fixing base is provided on each mounting surface. The fixing base has a lead wire fixing surface and a pole plate fixing surface that are opposite to each other along the thickness direction of the frame 11. The lead wire fixing surface is located on the lead wire fixing base 112, and the pole plate fixing surface is located on the pole plate fixing base 113. This structure allows the frame 11 to provide only one fixing seat during production to achieve auxiliary fixation of the side pole plate 26, the first lead wire 221 and the second lead wire 231, which can effectively simplify the structure and reduce the production cost.

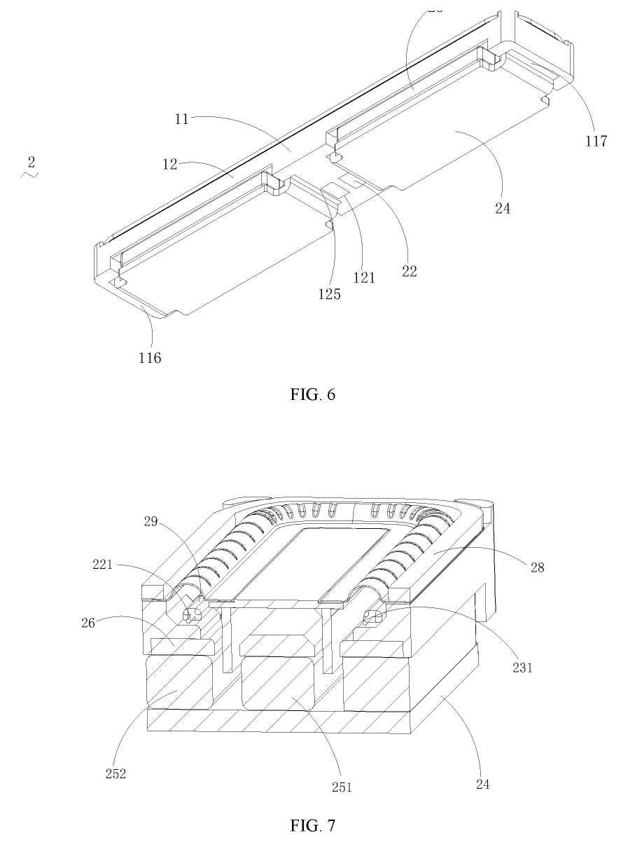

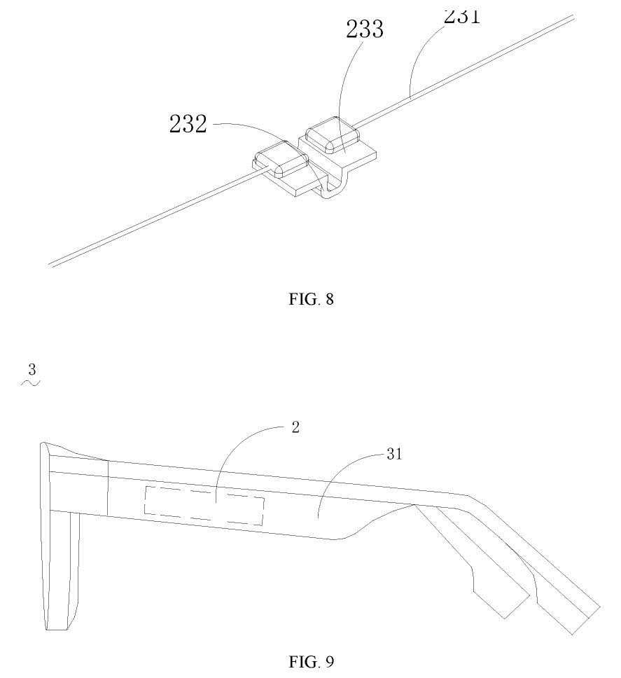

Referring to FIGS. 5 and 6 , in one embodiment, the speaker assembly includes two magnetic yokes 24 and two magnet assemblies 25. The two magnetic yokes 24 are both provided on the frame 11 and form two receiving spaces with the frame 11. The two receiving spaces are in communication with the two accommodating openings 111, respectively, so that the magnetic yokes 24, the magnet assemblies 25, the side pole plates 26, the voice coils 21 and other components can be received in the receiving spaces and accommodating openings 111.

The two magnet assemblies 25 are provided in two receiving spaces, respectively. Along the length direction of the frame 11, gaps are formed between both sides of the magnet assembly 25 and the magnetic yoke 24, so as to dissipate heat from the magnet assembly 25 and the voice coil 21 and other components located in the magnetic yoke 24.

Specifically, the frame 11 has a first surface 118 and a second surface 119 that are opposite to each other along the thickness direction thereof. Two connecting bases 116 are provided at both ends of the second surface 119 along the length direction of the frame 11. A side of the connecting base 116 facing the separating member 12 is provided with a first connecting groove 117. A side of the separating member 12 facing the connecting base 116 is provided with a second connecting groove 125. Two ends of a magnetic yoke 24 of the speaker device 2 can be fixed in the first connecting groove 117 and the second connecting groove 125, respectively, so as to achieve the connection between the magnetic yoke 24 and the frame 11.

More specifically, the magnetic yoke 24 includes a first connecting portion and two second connecting portions. The two second connecting portions are provided in the first connecting groove 117 and the second connecting groove 125, respectively. The first connecting portion is connected to the two second connecting portions. The receiving space is formed by the frame 11 and the magnetic yoke 24.

The first connecting portion is parallel to the second surface 119, so that the magnet assembly 25 can be connected to the first connecting portion. The first connecting portion and the second surface 119 are spaced apart along the thickness direction of the frame 11, so that the magnetic yoke 24 can cooperate with the frame 11 to form a large accommodating space. Gaps are formed between both sides of the magnet assembly 25 along the length direction of the frame 11 and the two second connecting portions respectively, so that external air can circulate through the gaps, thereby providing auxiliary heat dissipation for the magnet assembly 25 and voice coil 21 and other components located in the magnetic yoke 24.

Referring to FIGS. 5 to 7 , in one embodiment, the magnet assembly 25 includes a main magnet 251 and two secondary magnets 252, and the main magnet 251 is located between and spaced apart from the two secondary magnets 252 along the width direction of the frame 11. The combination of the main magnet 251 and two secondary magnets 252 can significantly enhance the magnetic field strength of the magnetic circuit of the speaker assembly, thereby improving the vibration efficiency of the voice coil 21.

Specifically, the main magnet 251 is provided on the first connecting portion of the magnetic yoke 24, and gaps are formed between both sides of the magnet assembly 25 along the length direction of the frame 11 and the two second connecting portions of the magnetic yoke 24 respectively, so that external air can circulate and dissipate heat through the gaps. A washer is provided on a side of the main magnet 251 away from the first connecting portion to enhance the magnetic flux density of the magnetic circuit and reduce magnetic leakage in the magnetic circuit. The voice coil 21 is sleeved on the outside of the main magnet 251. The voice coil 21 is sleeved on the main magnet 251.

The two secondary magnets 252 are both provided on the first connecting portion of the magnetic yoke 24, and gaps are formed between two sides of each of the two secondary magnets 252 along the length direction of the frame 11 and the two second connecting portions of the magnetic yoke 24 respectively, so that external air can circulate and dissipate heat through the gaps. A side of the secondary magnet 252 away from the first connecting portion is connected to the side pole plate 26, so that the side pole plate 26 can be used in conjunction with the magnet assembly 25 and the washer to enhance the magnetic flux density of the magnetic circuit and improve the efficiency of the magnetic circuit.

In one embodiment, the speaker assembly includes an upper cover 28, which is fixed on the first surface 118 through a fixing engagement base 115 to achieve the connection between the upper cover 28 and the frame 11, so that the upper cover 28 can effectively protect the diaphragm, the voice coil 21 and the magnetic circuit assembly inside the speaker device 2, thereby preventing external objects such as dust, moisture, etc. from entering to ensure the normal operation of the speaker device 2 and prolong its service life.

Specifically, the frame 11 has a first surface 118 and a second surface 119 that are opposite to each other along the thickness direction thereof. The fixing engagement base 115 is provided on each of four corners of the first surface 118, and four corners of the upper cover 28 are fixedly connected to the four fixing engagement bases 115 respectively.

Referring to FIG. 9, a smart glasses 3 is further provided according to an embodiment of the present disclosure, including a glasses body 31 and the speaker device 2 as described in any of the above embodiments, and the speaker device 2 is provided inside the glasses body 31. Specifically, the glasses body 31 includes temple arms, and the speaker device 2 is located inside the temple arm.

Specifically, referring to FIGS. 5 to 7, the speaker assembly includes components such as a voice coil 21, a first conductive member 22, a second conductive member 23, a magnetic yoke 24, a magnet assembly 25, a side pole plate 26, an upper cover 28, a diaphragm and other components. The conductive bracket 1 is used to combine the components of the speaker assembly to form the speaker device 2.

The conductive bracket 1 includes a frame 11 and a separating member 12. The frame 11 is provided with an accommodating space 110. The separating member 12 is provided on the frame 11 and divides the accommodating space 110 into two accommodating openings 111 spaced apart along a length direction of the frame 11. The frame 11 can accommodate two voice coils 21 through the two accommodating openings 111, thereby enabling the speaker device 2 mounted with the conductive bracket 1 to have a dual voice coil design, so that the speaker device 2 can achieve the best bass effect in a limited space.

A pole plate fixing base 113 is provided in each accommodating opening 111, which can fix a side pole plate 26 of the speaker device 2, so that the side pole plate 26 can be connected to the conductive bracket 1 in an embedded manner, thereby simplifying the structure of the conductive bracket 1 and reducing assembly cost. Two pole plate fixing bases 113 can be symmetrically arranged on two opposite sides of the accommodating opening 111 along a width direction of the frame 11, or symmetrically arranged on two opposite sides of the accommodating opening 111 along the length direction of the frame 11.

The separating member 12 is provided with a first mounting groove 121 and a second mounting groove 122 spaced apart along the width direction of the frame 11, so that the first conductive member 22 and the second conductive member 23 connecting the voice coils 21 in the two accommodating openings 111 can be mounted in the first mounting groove 121 and the second mounting groove 122, so as to be connected to the conductive bracket 1 in an embedded manner, which effectively simplifies the structure of the conductive bracket 1 and reduces the assembly cost.

In summary, according to the smart glasses 3, the side pole plate 26 is fixed through the pole plate fixing base 113 of the conductive bracket 1, so that the side pole plate 26 can be connected to the conductive bracket 1 in an embedded manner. At the same time, the first mounting groove 121 and the second mounting groove 122 for installing the first conductive member 22 and the second conductive member 23 are directly provided on the conductive bracket 1, so that the first conductive member 22 and the second conductive member 23 configured to be connected to the dual voice coils can be connected to the conductive bracket 1 in an embedded manner. The structure of the conductive bracket 1 is effectively simplified and the assembly cost is reduced, and the problem of large size of the speaker device 2 is solved.

The above-mentioned embodiments do not constitute a limitation on the protection scope of the technical solution. Any modifications, equivalent replacements and improvements made within the spirit and principles of the above-mentioned embodiments shall be included within the protection scope of this technical solution.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall all fall within the protection scope of the present disclosure. Therefore, the protection scope of the present disclosure shall be subject to the protection scope of the appended claims.

What is claimed is:

1. A conductive bracket for a speaker device, comprising:
a frame provided with an accommodating space;
a separating member provided on the frame and dividing the accommodating space into two accommodating openings spaced apart along a length direction of the frame, the separating member being further provided with a first mounting groove and a second mounting groove, the first mounting groove comprising two first grooves extending through the separating member along a thickness direction of the frame; and
a pole plate fixing base received in each accommodating opening, respectively.

2. The conductive bracket according to claim 1, wherein the pole plate fixing base comprises a plurality of first engagement structures spaced apart.

3. The conductive bracket according to claim 1, further comprising a lead wire fixing base received in each accommodating opening.

4. The conductive bracket according to claim 3, wherein the lead wire fixing base is connected to the pole plate fixing base.

5. The conductive bracket according to claim 1, wherein the two first grooves are spaced apart along the length direction of the frame.

6. The conductive bracket according to claim 5, wherein the second mounting groove comprises a connecting channel and two second grooves, the two second grooves are spaced apart along the length direction of the frame, and the connecting channel is in communication with the two second grooves.

7. The conductive bracket according to claim 6, wherein the second groove and the first groove are spaced apart along a width direction of the frame.

8. The conductive bracket according to claim 1, wherein the frame has a first surface and a second surface that are opposite to each other along the thickness direction thereof, and the conductive bracket further comprises four fixing engagement bases provided at four corners of the first surface, respectively.

9. The conductive bracket according to claim 8, wherein along the length direction of the frame, the conductive bracket further comprises two connecting bases provided at both ends of the second surface, a side of each connecting base facing the separating member is provided with a first connecting groove, and a side of the separating member facing the connecting base is provided with a second connecting groove.

10. A speaker device, comprising the conductive bracket according to claim 1 and a speaker assembly provided on the conductive bracket.

11. The speaker device according to claim 10, wherein the speaker assembly comprises:
two voice coils located in two accommodating openings, respectively;
two first conductive members provided in the two first grooves and connected to the two voice coils through two first lead wires, respectively, and
a second conductive member provided in the second groove and connected to the two voice coils through two second lead wires.

12. The speaker device according to claim 11, wherein a length of the first conductive member along the thickness direction of the frame is greater than or equal to a length of the separating member along the thickness direction of the frame.

13. The speaker device according to claim 11, wherein the second conductive member comprises a connecting bending portion and two connecting ends, the two connecting ends are located in two second grooves, respectively, and the connecting bending portion is provided inside the separating member and is connected between the two connecting ends.

14. The speaker device according to claim 11, wherein the conductive bracket comprises a lead wire fixing base received in each accommodating opening, and the first lead wire is fixed to the lead wire fixing base by a damping adhesive.

15. The speaker device according to claim 11, wherein the conductive bracket comprises a lead wire fixing base received in each accommodating opening, and the second lead wire is fixed to the lead wire fixing base by a damping adhesive.

16. The speaker device according to claim 11, wherein the speaker assembly further comprises:
two magnetic yokes provided on the frame and forming two receiving spaces with the frame, the two receiving spaces being in communication with the two accommodating openings, respectively; and
two magnet assemblies received in the two receiving spaces, respectively, and gaps being formed between both sides of each magnet assembly along the length direction of the frame and each magnetic yoke.

17. The speaker device according to claim 16, wherein each magnet assembly comprises a main magnet and two secondary magnets, and the main magnet is located between and spaced apart from the two secondary magnets along a width extension of the frame.

18. The speaker device according to claim 10, wherein the speaker assembly comprises a side pole plate provided on the pole plate fixing base, the conductive bracket comprises a first engagement structure, and the side pole plate is provided with a second engagement structure engaged with the first engagement structure.

19. The speaker device according to claim 10, wherein the speaker assembly comprises an upper cover, the conductive bracket comprises a fixing engagement base, and the upper cover is fixed on a first surface of the frame through the fixing engagement base.

20. A smart glasses, comprising a glasses body and the speaker device according to claim 10, and the speaker device being provided inside the glasses body.
